(19) United States
(12) Patent Application Publication
(10) Pub. No.: US 2026/0119520 A1
(43) Pub. Date: Apr. 30, 2026

(54) Automatic Generation of ETL to Transform from Normalized Database Tables and Metadata to Star Schema Denormalized Dimensions

(71) Applicant: Oracle International Corporation, Redwood Shores, CA (US)

(72) Inventor: Michael Sassin, Andover, MA (US)

(73) Assignee: Oracle International Corporation, Redwood Shores, CA (US)

(21) Appl. No.: 19/054,414

(22) Filed: Feb. 14, 2025

Related U.S. Application Data
(60) Provisional application No. 63/714,554, filed on Oct. 31, 2024.

(51) Int. Cl. G06F 16/25; G06F 16/21; G06F 16/2455

(52) U.S. Cl. CPC G06F 16/254; G06F 16/212; G06F 16/2456

(57) ABSTRACT

Techniques for embodiments generating ETL code for transforming normalized database tables, i.e., snowflake schema, and metadata from an operational database into star schema denormalized dimensions are disclosed. The system accesses metadata associated with the normalized database tables and analyzes the metadata to identify tables and relationships between the tables. Identifying tables includes identifying fact tables and dimension tables referenced by the fact tables. Pattern matching may be used to identify the tables within the normalized dimensions. The tables and the relationships between the tables are parsed to generate an abstract representation, i.e., abstract syntax tree, of the normalized database tables. The system generates an intermediate representation from the abstract representation that defines operations for denormalizing the normalized dimensions. The system renders the operations defined in the intermediate representation into ETL code for creating denormalized dimensions from the normalized dimensions in the operational database.

### BENEFIT CLAIMS; RELATED APPLICATIONS; INCORPORATION BY REFERENCE

This application claims the benefit of U.S. Provisional Patent Application 63/714,554, filed Oct. 31, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

U.S. Pat. No. 10,169,378 titled, “Automatic Generation of Logical Database Schemas from Physical Database Tables and Metadata,” filed Sep. 11, 2014, and The Data Warehouse Tool Kit, Third Edition. Kimball, et al. (2013) are hereby incorporated by reference.

### TECHNICAL FIELD

The present disclosure relates to operational databases. In particular, the present disclosure relates to generating ETL (Extract, Transform, Load) code to transform normalized database tables and metadata to star schema denormalized dimensions.

### BACKGROUND

Operational databases are systems designed to manage day-to-day transactional data for an organization, supporting applications like customer relationship management (CRM), enterprise resource planning (ERP), and e-commerce platforms. Operational databases typically use a normalized schema to optimize storage efficiency and ensure data consistency.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a system in accordance with one or more embodiments;

FIG. 1B illustrates a machine learning model engine in accordance with one or more embodiments;

FIG. 2 illustrates an example set of operation of a machine learning engine;

FIG. 3 illustrates an example set of operations for generating ETL code to transform normalized database tables and metadata to star schema denormalized dimensions in accordance with one or more embodiments;

FIG. 4A illustrates metadata tables representing a normalized database schema;

FIG. 4B illustrates a graphical representation of the normalized database schema of FIG. 4B;

FIG. 4C illustrates an abstract syntax tree for the normalized database schema of FIG. 4A;

FIG. 4D illustrates intermediate representations of the dimensions from the abstract syntax tree of FIG. 4C;

FIG. 4E illustrates example SQL for denormalizing dimensions in the normalized database schema of FIG. 4A;

FIG. 4F illustrates example FDI LoCode for denormalizing dimensions in the normalized database schema, and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DENORMALIZED DIMENSION GENERATOR SYSTEM ARCHITECTURE
3. MACHINE LEARNING ENGINE ARCHITECTURE
4. MACHINE LEARNING ENGINE OPERATION
5. GENERATING ETL CODE TO TRANSFORM NORMALIZED DATABASE TABLES AND METADATA TO STAR SCHEMA DENORMALIZED DIMENSIONS
6. EXAMPLE GENERATION OF ETL CODE FOR DENORMALIZING DIMENSIONS
7. PRACTICAL APPLICATIONS, ADVANTAGES & IMPROVEMENTS
8. HARDWARE OVERVIEW
9. MISCELLANEOUS; EXTENSIONS

### 1. General Overview

One or more embodiments generate ETL (Extract, Transform, Load) code for transforming normalized database tables and metadata from an operational database into star schema denormalized dimensions. The system accesses metadata associated with the normalized database tables. The metadata is analyzed to identify the tables and relationships between the tables, which may be arranged in a snowflake schema. Identifying tables includes identifying fact tables and dimension tables referenced by the fact tables. Pattern matching may be used to identify the tables within the normalized dimensions. The tables and the relationships between the tables are parsed to generate abstract representations of the normalized database tables, such as an abstract syntax tree. Parsing the tables and the relationships between the tables includes identifying: (a) cardinality of the tables, (b) hierarchies of the tables, and (c) parent-child relationships between the tables. The system generates an intermediate representation from the abstract representation that defines operations for denormalizing the normalized dimensions. The system renders the operations defined in the intermediate representation into a target code, e.g., ETL code, for creating denormalized dimensions from the normalized dimensions.

One or more embodiments analyze scoping metadata to determine when a table and/or column of a table is in scope for a solution. Tables and/or columns that are not in scope are excluded from the particular dimension.

One or more embodiments implement the ETL code on the normalized dimensions in the operational database to generate denormalized dimensions. The system may execute one or more queries on the denormalized dimensions.

One or more embodiments described in this Specification and/or recited in the claims may not be included in this General Overview section.

### 2. Denormalized Dimension Generator System Architecture

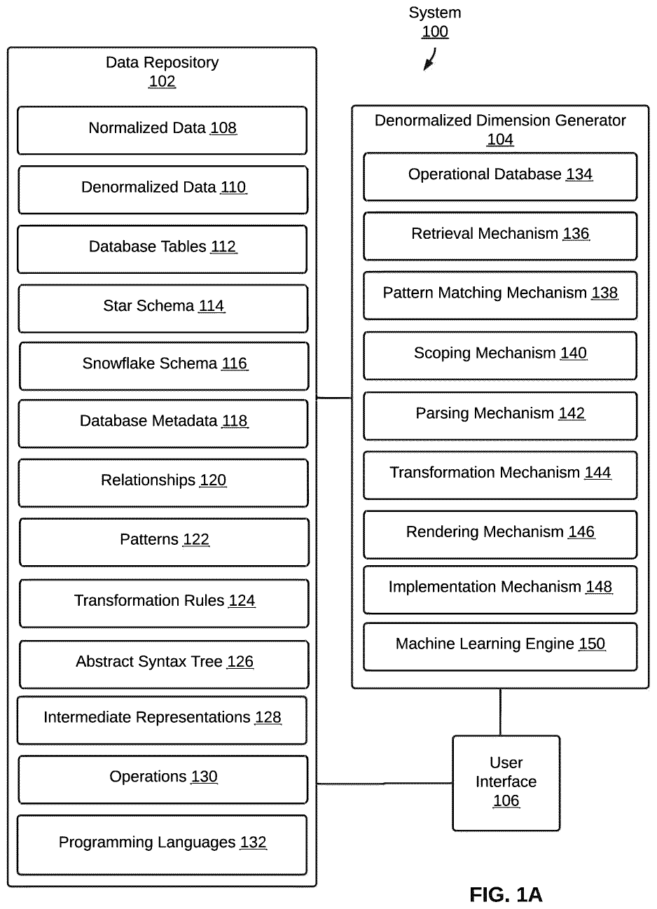

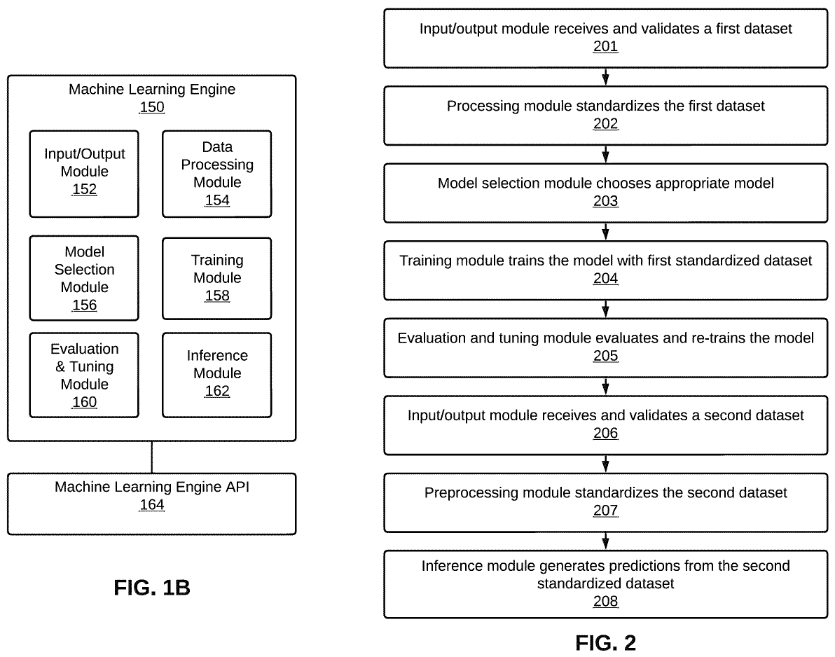

FIG. 1A illustrates a system 100 in accordance with one or more embodiments. As illustrated in FIG. 1A, system 100 includes a data repository 102, a denormalized dimension generator 104, and a user interface 106. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, a data repository 102 is any type of storage unit and/or device (e.g., a file system, database, collection of tables, or any other storage mechanism) for storing data. Further, a data repository 102 may include multiple different storage units and/or devices. The multiple different storage units and/or devices may or may not be of the same type or located at the same physical site. Further, a data repository 102 may be implemented or executed on the same computing system as denormalized dimension generator 104. Additionally, or alternatively, a data repository 102 may be implemented or executed on a computing system separate from denormalized dimension generator 104. The data repository 102 may be communicatively coupled to denormalized dimension generator 104 via a direct connection or via a network.

Information describing denormalized dimension generator 104 may be implemented across any components within the system 100. However, this information is illustrated within the data repository 102 for purposes of clarity and explanation.

In one or more embodiments, data repository 102 includes normalized data 108, denormalized data 110, database tables 112, star schema 114, snowflake schema 116, database metadata 118, relationships 120, patterns 122, transformation rules 124, abstract syntax tree 126, intermediate representations 128, ETL operations 130, and programming languages 132.

In one or more embodiments, normalized data 108 refers to data that is organized to eliminate redundancy, ensure data consistency, and establish clear relationships between tables. The process of normalization structures data according to predefined rules, called normal forms, which aim to improve the efficiency, integrity, and scalability of the database. In normalized data 108, each piece of information is stored in only one place to avoid duplication. Updates, deletions, and insertions are less prone to introducing inconsistencies because data is not duplicated across multiple tables. Data is divided into multiple related tables connected through primary keys and foreign keys. Changes to the schema are easier to implement as data relationships are clearly defined. Each column in normalized data contains indivisible values, adhering to the principle of atomicity in normalization.

In one or more embodiments, denormalized data 110 refers to data where redundancy is intentionally introduced to improve query performance by reducing the need for joins. Unlike normalized data 108, which divides data into multiple related tables, denormalized data 110 consolidates related information into fewer tables or even a single table, making retrieval of data easier and faster. Denormalized data 110 includes information repeated across rows and tables, leading to larger storage requirements. Joins between multiple tables are minimized or eliminated, resulting in faster query performance. Denormalized data 110 is common in analytical systems, e.g., data warehouses, where quick aggregation and reporting are prioritized over update efficiency.

In one or more embodiments, database tables 112 include fact tables and dimension tables. Fact tables are central tables in a star schema or snowflake schema that store quantitative data for analysis. Fact tables contain numerical or measurable data, e.g., sales amount, quantity, revenue, profit. Fact tables contain foreign keys referencing dimension tables to describe the context of the measurements, e.g., time, location, product. Dimension tables contain textual or descriptive information, often referred to as attributes, that provide context for facts, e.g., product name, customer name, date. Dimension tables are a key component of star and snowflake schemas, used in data warehouses and analytical systems to help users interpret and analyze data. Each dimension table has a primary key that uniquely identifies each record and links to the corresponding foreign key in the fact table. Dimension tables may have fewer rows and many columns to capture rich descriptive data. Attributes in dimension tables can define hierarchies for analysis, e.g., Year→Quarter→Month→Day in a Date dimension.

In one or more embodiments, database tables 112 include lookup tables, bridge tables, language tables, outrigger tables, characteristic tables, and identifier tables. Lookup tables provide mappings or translation between codes and descriptive values. Bridge tables, also referred to as junction tables, resolve many-to-many (N:N) relationships between tables. Language tables enable internationalization (118n) by storing translations or localized versions of data, e.g., names, descriptions, labels. Outrigger tables are related to a dimension table and provide additional descriptive or hierarchical data. Characteristic tables store attributes or properties associated with an entity in the database. Characteristic tables are useful in managing data where entities have a variable number of characteristics or attributes. Identifier tables map unique codes or identifiers to descriptive names or details. Identifier tables ensure consistency and standardization across a schema.

In one or more embodiments, star schema 114 is a type of database schema used in data warehousing and business intelligence to structure data for efficient querying and reporting. Star schema 114 organizes data into a central fact table surrounded by dimension tables, forming a star-like pattern.

In one or more embodiments, snowflake schema 116 is a logical arrangement of tables in a relational database where the dimension tables are normalized into multiple related tables. Snowflake schema 116 is an extension of star schema 114, designed to reduce redundancy and improve storage efficiency.

In one or more embodiments, database metadata 118 refers to descriptive information about the structure, organization, and content of a database. Database metadata 118 serves as a “data about data” layer that allows users, applications, and systems to understand the schema of a database, objects, and relationships. Database metadata 118 may include structural metadata, operational metadata, descriptive metadata, and statistical metadata. Structural metadata describes database schema including tables, columns, data types, primary and foreign keys, indexes, constraints, and relationships between tables. Operational metadata captures data lineage, ETL processes, and job scheduling as well as tracks refresh schedules and operation status. Descriptive metadata includes business-level definitions of tables, columns, and relationships, and semantic models, e.g., logical dimensions and facts. Statistical metadata includes row counts, column uniqueness, nullability, and distribution statistics.

In one or more embodiments, database metadata 118 includes analytics visualization (AV) metadata. AV metadata extends traditional database metadata to include details about how data is presented, transformed, and consumed in analytics and reporting tools. AV metadata may include presentation metadata, dimensional metadata, calculated fields and metrics, filter and parameters, localization and language settings, data source metadata, and scoping metadata. Presentation metadata may provide information about visual objects like charts, graphs, and tables, and includes definitions of axes, labels, colors, and legends. Dimensional metadata includes definitions of logical dimensions and hierarchies and relationships between dimensions and fact tables. Calculated fields and metrics include metadata for derived measures, e.g., “profit margin”=revenue-cost, and transformation logic applied at a reporting layer. Filters and parameters include predefined filter sets and customized parameters for users. Localization and language settings include metadata for dynamic language selection and locale-based formatting, i.e., dates, numbers. Data source metadata tracks underlying source systems, query structure, and connection details. Scoping metadata defines the tables or entities that are relevant for a specific context, project, or application. Scoping metadata may detail tables that are required for a solution, tables excluded from the solution, specific columns or fields relevant to the solution, and relationships and keys, i.e., foreign or primary, that define how the tables are connected and are included.

In one or more embodiments, relationships 120 refer to connections or associations between tables based on shared data elements. Relationships 120 define how data in one table is related to data in another. Relationships are fundamental in organizing and structuring data across multiple tables, ensuring that the data can be efficiently queried, updated, and maintained. Relationships 120 may include one-to-one (1:1), one-to-many (1:N), many-to-many (M:N), self-referencing relationships, and optional relationships including zero-to-one to one (0 . . . 1:1) and zero-to-one to many (0 . . . 1:N). In a one-to-one relationship, a single row in one table is related to a single row in another table. More particularly, a foreign key in one table points to a primary key of another table. In one-to-many relationships, a single row in a first table can be associated with multiple rows in a second table, however, each row in the second table is related to only one row in the first table. More particularly, a “many” table, e.g., order table, has a foreign key that points to a primary key on a “one” table. In a many-to-many relationship, multiple rows in one table can be related to multiple rows in another table. Many-to-many relationships may be implemented through a junction table, also called a bridge table or a link table, that contains foreign keys from both related tables. Self-referencing relationships are tables that have a relationship with itself. In a zero-to-one to one relationship, a single row in a first table is related to zero or one row in a second table, and single row in the second table must relate to a single row in the first table. In a zero-to-one to many relationships, a single row in a first table is related to zero or one row in a second table, and a single row in the second table is related to multiple rows in the first table.

In one or more embodiments, patterns 122 are solutions to common scenarios found in normalized dimensions. For a complete list of patterns, please refer to “The Data Warehouse Toolkit,” by Ralph Kimball. Patterns 122 are established templates or best practices used to identify database schema. Patterns 122 may include role-playing dimensions, min dimensions, shrunken dimensions, degenerated dimensions, multi-valued dimensions with bridge tables, dimension table with embedded hierarchies, shared dimensions, outrigger tables, bridge between dimensions, aggregation tables, and logical hierarchies. Role-playing dimensions are single dimension tables that play multiple roles in a schema by being referenced with different context-specific aliases. Mini dimensions are a smaller subset of larger dimensions used to store high-cardinality or frequently changing attributes separately. Shrunken dimension are reduced versions of full dimensions, and may be used for aggregate fact tables. Degenerated dimensions include attributes that are not part of a separate dimension table and are stored directly in a fact table. Multi-valued dimensions with bridge tables handle many-to-many (N:N) relationships between dimensions and facts using bridge tables. Dimension tables with embedded hierarchies include hierarchical relationships embedded directly within a dimension table. Shared dimensions are referenced by multiple fact tables, allowing reuse without duplication. Outrigger tables are dimensions with additional details stored in secondary tables linked to a main dimension. Bridge between dimensions model relationships between two dimensions using bridge tables. Aggregation tables are fact tables at different levels of granularity, and may be used for pre-aggregated data. A detailed description of this and additional patterns may be found with reference to U.S. Pat. No. 10,169,378.

In one or more embodiments, transformation rules 124 include rules that are taken into consideration for creation of denormalized dimensions. Transformation rules 124 may include rules for identifying tables, rules for identifying relationships, rules for joining tables, and rules for addressing column collisions. Transformation rules 124 may include ignoring foreign key constraints when at least one foreign key column is not mapped in scoping metadata. Resulting datasets columns that are explicitly excluded in the scoping metadata, e.g., VERSION, BLOB/CLOB columns etc., are not included in the scope for the solution. Transformation rules 124 may include identifying a table as a base of a dimension table when a fact table refers to the table with a foreign key. Transformation rules 124 may joining a table “T” of a dimension table with another table “P” with an inner/left outer join when table “T” defines a not nullable/nullable FK to parent table “P”. Transformation rules 124 may include only integrating a child table “C” referring to a parent table “T” of a dimension into the dimension when the child table has either a 1:1 or 0 . . . 1:1 relationship with its parent or a dataset can be produced with the same cardinality.

Transformation rules 124 may include retaining primary key columns of the parent table and may eliminating duplicate foreign key columns of the child table. Transformation rules 124 may include defining a default row representing a reference in all dimension tables, with other default rows being added over time. Transformation rules 124 may include various conventions for handling column collisions when mapping columns with the same name to a dimension table.

In one or more embodiments, transformation rules 124 for AV metadata includes (i) pivoting multiple into maximal one row, e.g., characteristics or identifier tables, (ii) applying a filter to extract maximally one child table row per parent table primary key, or (iii) aggregating child table rows so that maximally one child table row per parent table primary key is returned. A child table or dataset based on a child table is joined with an inner/left outer join if the cardinality of the child table/dataset is 1:1/0 . . . 1:1. Transformation rules 124 may include defining default values to (i) use ‘-’ to replace null for VARCHAR, and (ii) return NULL for NULL Dates, Date/Time, Timestamp, and numbers. The table DDL may reflect this arrangement by making the columns nullable.

In one or more embodiments, abstract syntax tree (AST) 126 is an object model that represents structure and relationships between tables in the database schema. AST 126 abstract away unnecessary details, e.g., punctuation, formatting, or specific SQL syntax. AST 126 primarily focuses on entities, e.g., tables and the relationships, i.e., primary keys, foreign keys, in the normalized database schema. Each node of AST 126 represents a syntactic construct, and the edges represent the relationship between the constructs. In AST 126, each table in the database is represented as a node in the tree. AST 126 focuses on the table and a role or pattern of the table. For example, a table may be a base dimension table, i.e., a start of a dimension, referenced by a fact table. A related node may be that of a parent table described as an outrigger. An outrigger may refer to specific columns with different node types, e.g., description column, denormalized dimension. Constraints such as unique keys, foreign keys, and check constraints may be captured by metadata referred to by a node of AST 126. In this manner, the nodes of AST 126 describe the patterns, and content of the nodes may refer to a table, column, FK, and/or PK depending on the pattern.

In one or more embodiments, intermediate representations 128, also define structure that serves as a bridge between the source database schema, i.e., normalized form, and the target schema, i.e., denormalized dimension tables. Intermediate representations 128 capture transformations, relationships, and operations required to convert the normalized dimension into the denormalized dimensions. Intermediate representations 128 define ETL operations such as joining tables, flattening hierarchical relationships, and handling data aggregation. Intermediate representations 128 outline the steps needed to produce the target denormalized schema, e.g., star schema, from the normalized data.

In one or more embodiments, ETL operations 130 define operations for denormalizing the normalized dimensions. ETL operations 130 may include joining tables, flattening hierarchical relationships, applying filters and conversion functions, and handling data aggregation. Joining tables is the process of combining data from two or more tables based on a common key. In a normalized schema, data is spread across multiple tables, and joins are necessary to combine related information. Inner joins combine rows from both tables where there is a match on a specified join condition. Left join, also referred to as left outer join, combines all rows from a left table and matching rows from a right table. If no match, NULL values are returned for columns from the right table. A default may be returned based on data type or other classification of a column. Right join, also referred to as right outer join, is similar to left join but returns all rows from the right table and the matching rows from the left table. Full outer join combines rows from both tables, with NULL values where there is no match. Other joins that may be used, depending on the situation, include full or cross joins. Full joins and cross joins are used to combine data from two tables. A full join returns all records from both tables. In a full join, if there is a match, the result includes the combined row, and if there is no match, the missing side is filled with NULL. A cross join returns every possible combination of rows from both tables. A cross join does not use a matching condition. A number of rows in resulting table is a number of rows in a first table times the number of rows in the second table.

Hierarchical relationships often appear in dimension tables. For example, a time dimension may have hierarchy of Year>Month>Day, or a geography dimension may have Country>Region>City. Flattening these hierarchies means transforming the hierarchical structure into a flat table with all necessary attributes available at a single level. Hierarchical flattening involves combining multiple columns from different levels of the hierarchy into a single row, often with the Year, Month, and Day as separate attributes in the same table. Transformation might include creating a new dimension that includes all possible combinations of the hierarchy.

Filters may restrict data included in a result set by applying conditions, e.g., “where” or “having” clause in SQL. Filters may remove data inconsistencies and defective data rows in the generated ETL. Filters may refine a dataset by including only rows that meet specific criteria, e.g., conditions on values—grade is NOT NULL, comparisons—Credits>0, or date ranges—EnrollmentDate BETWEEN ‘2024-01-01’ AND ‘2024-12-31’.

Conversion functions transform or format data in specific ways. Conversion functions may be implemented as built-in functions provided by SQL or programming languages. NVL( ) may be used to handle null values and replace the null values with default values. CAST may be used in combination with trim( ) to convert data types while trimming unnecessary spaces. This is especially useful for CHAR to VARCHAR conversions. Conversion functions may include string operations, e.g., UPPER( ) to convert text to uppercase, CONCAT( ) to concatenate two strings, date formatting, e.g., DATE_FORMAT( ) to change the format of a date, arithmetic operations, e.g., ROUND( ) to round numeric values, and aliases, e.g., AS to assign new names to derived columns. Other transformations may include pivot operations.

Data aggregation refers to summarizing data, typically from a fact table, for analysis and may involve operations such as SUM, COUNT, AVG, MIN, MAX. Aggregation is performed at the dimension level where data is grouped by certain attributes, e.g., product_id, customer_id, or time_id. Aggregated data may be inserted into fact tables, commonly referred to as aggregate tables.

In one or more embodiments, programming languages 132 refer to programming languages used for Extract, Transform, Load (ETL) processes. Programming languages 132 may include Structured Query Language (SQL), Python, Java, Scala, and Oracle Fusion Data Intelligence (FDI) LoCode. FDI LoCode is an ETL technique designed to handle complex data structures and varying data formats. Programming languages 132 may include commercially available ETL tools. The ETL tools operate with ETL primitives that are similar to language elements.

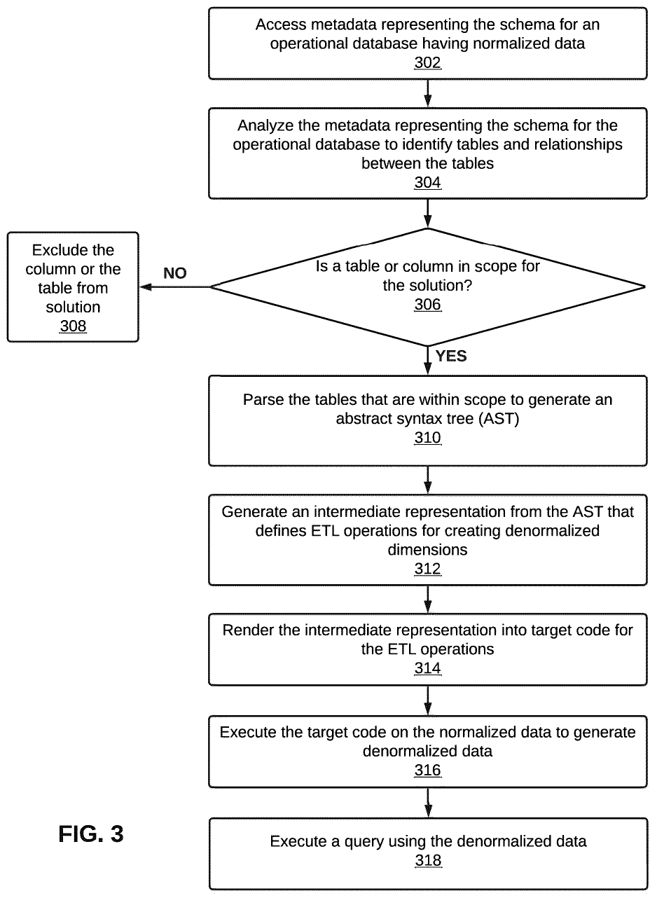

In one or more embodiments, denormalized dimension generator 104 refers to hardware and/or software configured to perform operations described herein for generating denormalized dimensions from normalized dimensions. Examples of operations for generating denormalized dimensions from normalized dimensions are described below with reference to FIG. 3.

In an embodiment, denormalized dimension generator 104 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, denormalized dimension generator 104 includes an operational database 134. Operational database 134 is a type of database optimized for managing and storing real-time transactional data for day-to-day business operations. Operational database 134 is designed to handle real-time updates and queries for transactional data. Data in operational database 134 is stored in a normalized structure to reduce redundancy and ensure data consistency. Tables in operational database 134 are related using foreign keys, enabling efficient updates and inserts.

In one or more embodiments, denormalized dimension generator 104 includes retrieval mechanism 136. Retrieval mechanism 136 refers to hardware and/or software configured to perform operations described herein for retrieving database metadata 118 from operational database 134.

In one or more embodiments, denormalized dimension generator 104 includes pattern matching mechanism 138. Pattern matching mechanism 138 refers to hardware and/or software configured to perform operations described herein for identifying table types and relationships between tables in normalized dimensions. Pattern matching mechanism 138 uses database metadata 118 and table properties to identify fact tables, base tables for normalized dimensions, primary keys, foreign keys, naming conventions, and schema-level relationships. Pattern matching mechanism 138 may incorporate machine learning to assist in identifying fact tables, base dimension tables, and/or patterns in the normalized dimensions. Pattern matching mechanism 138 may handle different solution patterns, e.g., text labels into a dimensional table, or externalize tables in language tables supporting multiple languages. I18N label lookup tables may be used to provide descriptions or labels for code columns.

In one or more embodiments, denormalized dimension generator 104 includes scoping mechanism 140. Scoping mechanism 140 refers to hardware and/or software configured to perform operations described herein for determining dimensions that are in scope for a solution. Scoping mechanism 140 may use preexisting scoping metadata to define the scope of a solution. Alternatively, or additionally, scoping mechanism 140 may analyze database schema, metadata, and/or business requirements to identify dimensions relevant to a solution. Scoping mechanism 140 may use a nesting limit of three levels unless specified differently. For example, including only a parent or its grandparent, or including certain child tables with a specific structure or naming convention. Scoping mechanism 140 may incorporate machine learning to assist in the scoping process.

In one or more embodiments, denormalized dimension generator 104 includes parsing mechanism 142. Parsing mechanism 142 refers to hardware and/or software configured to perform operations described herein for parsing the tables and relationships between the tables and generating the AST.

In one or more embodiments, denormalized dimension generator 104 includes transformation mechanism 144. Transformation mechanism 144 refers to hardware and/or software configured to perform operations described herein for transforming the AST into an intermediate representation of the denormalized dimensions. Transformation mechanism 144 identifies transformation logic to create the denormalized dimensions. The transformation logic may be generic, i.e., does not target a specific language or platform.

In one or more embodiments, denormalized dimension generator 104 includes rendering mechanism 146. Rendering mechanism 146 refers to hardware and/or software configured to perform operations described herein for rendering ETL code from the intermediate representation. Rendering mechanism 146 may include an ETL platform, e.g., Oracle Data Integrator, Informatica PowerCenter, Azure Data Factory. Rendering mechanism 146 may also include SQL or PL/SQL or operation in the semantic model of a business intelligence (BI) tool.

In one or more embodiments, denormalized dimension generator 104 includes implementation mechanism 148. Implementation mechanism 148 refers to hardware and/or software configured to perform operations described herein for instantiating the ETL code for denormalizing the normalized dimensions on an operational database.

In one or more embodiments, denormalized dimension generator 104 includes a machine learning engine 150. Machine learning engine 150 refers to hardware and/or software configured to perform operations described below with reference to FIG. 1B.

In one or more embodiments, user interface 106 refers to hardware and/or software configured to facilitate communications between a user and denormalized dimension generator 104. User interface 106 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of user interface 106 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, user interface 106 is specified in one or more other languages, such as Java, C, or C++.

### 3. Machine Learning Architecture

FIG. 1B illustrates a machine learning engine 150 in accordance with one or more embodiments. As illustrated in FIG. 1B, machine learning engine 150 includes input/output module 152, data preprocessing module 154, model selection module 156, training module 158, evaluation and tuning module 160, and inference module 162.

In accordance with an embodiment, input/output module 152 serves as the primary interface for data entering and exiting the system, managing the flow and integrity of data. This module may accommodate a wide range of data sources and formats to facilitate integration and communication within the machine learning architecture.

In an embodiment, an input handler within input/output module 152 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 152 to be versatile in different operational contexts, whether processing historical datasets or streaming data.

In accordance with an embodiment, input/output module 152 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 152 includes an output framework designed to handle the distribution and exportation of outputs, predictions, or insights. Using the output framework, input/output module 152 formats these outputs into user-friendly and accessible formats, such as reports, visualizations, or data files compatible with other systems. Input/output module 152 also ensures secure and efficient transmission of these outputs to end-users or other systems in an embodiment and may employ encryption and secure data transfer protocols to maintain data confidentiality.

In accordance with an embodiment, data preprocessing module 154 transforms data into a format suitable for use by other modules in machine learning engine 150. For example, data preprocessing module 154 may transform raw data into a normalized or standardized format suitable for training ML models and for processing new data inputs for inference. In an embodiment, data preprocessing module 154 acts as a bridge between the raw data sources and the analytical capabilities of machine learning engine 150.

In an embodiment, data preprocessing module 154 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 154 may be configured to handle anomalies in different ways depending on context. Data preprocessing module 154 also handles the normalization of numerical data in preparation for use with models sensitive to the scale of the data, like neural networks and distance-based algorithms. Normalization techniques, such as min-max scaling or Z-score standardization, may be applied to bring numerical features to a common scale, enhancing the model's ability to learn effectively.

In an embodiment, data preprocessing module 154 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 154 processes new data for inference, data preprocessing module 154 replicates the same preprocessing steps to ensure consistency with the training data format. This helps to avoid discrepancies between the training data format and the inference data format, thereby reducing the likelihood of inaccurate or invalid model predictions.

In an embodiment, model selection module 156 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 156 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 156 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 156 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 156 also considers computational efficiency and resource constraints. This is meant to help ensure the selected model is both accurate and practical in terms of computational and time requirements. In an embodiment, certain features of model selection module 156 are configurable such as a configured bias toward (or against) computational efficiency.

In accordance with an embodiment, training module 158 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 158 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 158 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 158 includes logic to handle different types of data and learning tasks. For instance, it includes different training routines for supervised learning (where the training data comes with labels) and unsupervised learning (without labeled data). In the case of deep learning models, training module 158 also manages the complexities of training neural networks that include initializing network weights, choosing activation functions, and setting up neural network layers.

In an embodiment, evaluation and tuning module 160 incorporates dynamic feedback mechanisms and facilitates continuous model evolution to help ensure the system's relevance and accuracy as the data landscape changes. Evaluation and tuning module 160 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 160 performs continuous model tuning by using hyperparameter optimization. Evaluation and tuning module 160 performs an exploration of the hyperparameter space using algorithms, such as grid search, random search, or more sophisticated methods like Bayesian optimization. Evaluation and tuning module 160 uses these algorithms to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 160 integrates data feedback and updates the model. Evaluation and tuning module 160 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 160 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 160 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 162 transforms data raw data into actionable, precise, and contextually relevant predictions. In addition to processing and applying a trained model to new data, inference module 162 may also include post-processing logic that refines the raw outputs of the model into meaningful insights.

In an embodiment, inference module 162 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 162 transforms the outputs of a trained model into definitive classifications. Inference module 162 employs the underlying model as a tool to generate probabilistic outputs for each potential class. It then engages in an interpretative process to convert these probabilities into concrete class labels.

In an embodiment, when inference module 162 receives the probabilistic outputs from the model, it analyzes these probabilities to determine how they are distributed across some or every potential class. If the highest probability is not significantly greater than the others, inference module 162 may determine that there is ambiguity or interpret this as a lack of confidence displayed by the model.

In an embodiment, inference module 162 uses thresholding techniques for applications where making a definitive decision based on the highest probability might not suffice due to the critical nature of the decision. In such cases, inference module 162 assesses if the highest probability surpasses a certain confidence threshold that is predetermined based on the specific requirements of the application. If the probabilities do not meet this threshold, inference module 162 may flag the result as uncertain or defer the decision to a human expert. Inference module 162 dynamically adjusts the decision thresholds based on the sensitivity and specificity requirements of the application, subject to calibration for balancing the trade-offs between false positives and false negatives.

In accordance with an embodiment, inference module 162 contextualizes the probability distribution against the backdrop of the specific application. This involves a comparative analysis, especially in instances where multiple classes have similar probability scores, to deduce the most plausible classification. In an embodiment, inference module 162 may incorporate additional decision-making rules or contextual information to guide this analysis, ensuring that the classification aligns with the practical and contextual nuances of the application.

In regression models, where the outputs are continuous values, inference module 162 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 162 incorporates domain-specific adjustments into its post-processing routine. This involves tailoring the model's output to align with specific industry knowledge or contextual information. For example, in financial forecasting, inference module 162 may adjust predictions based on current market trends, economic indicators, or recent significant events, ensuring that the outputs are both statistically accurate and practically relevant.

In an embodiment, inference module 162 includes logic to handle uncertainty and ambiguity in the model's predictions. In cases where inference module 162 outputs a measure of uncertainty, such as in Bayesian inference models, inference module 162 interprets these uncertainty measures by converting probabilistic distributions or confidence intervals into a format that can be easily understood and acted upon. This provides users with both a prediction and an insight into the confidence level of that prediction. In an embodiment, inference module 162 includes mechanisms for involving human oversight or integrating the instance into a feedback loop for subsequent analysis and model refinement.

In an embodiment, inference module 162 formats the final predictions for end-user consumption. Predictions are converted into visualizations, user-friendly reports, or interactive interfaces. In some systems, like recommendation engines, inference module 162 also integrates feedback mechanisms, where user responses to the predictions are used to continually refine and improve the model, creating a dynamic, self-improving system.

### 4. Machine Learning Engine Operations

FIG. 2 illustrates the operation of a machine learning engine in one or more embodiments. In an embodiment, input/output module 152 receives a dataset intended for training (Operation 201). This data can originate from diverse sources, like databases or real-time data streams, and in varied formats, such as CSV, JSON, or XML. Input/output module 152 assesses and validates the data, ensuring its integrity by checking for consistency, data ranges, and types.

In an embodiment, training data is passed to data preprocessing module 154. Here, the data undergoes a series of transformations to standardize and clean it, making it suitable for training ML models (Operation 202). This involves normalizing numerical data, encoding categorical variables, and handling missing values through techniques like imputation.

In an embodiment, prepared data from the data preprocessing module 154 is then fed into model selection module 156 (Operation 203). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 158 trains the selected model with the prepared dataset (Operation 204). It implements learning algorithms to adjust the model's internal parameters, optimizing them to identify patterns and relationships in the training data. Training module 158 also addresses the challenge of overfitting by implementing techniques, like regularization and early stopping, ensuring the model's generalizability.

In an embodiment, evaluation and tuning module 160 evaluates the trained model's performance using the validation dataset (Operation 205). Evaluation and tuning module 160 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 152 receives a dataset intended for inference. Input/output module 152 assesses and validates the data (Operation 206).

In an embodiment, data preprocessing module 154 receives the validated dataset intended for inference (Operation 207). Data preprocessing module 154 ensures that the data format used in training is replicated for the new inference data, maintaining consistency and accuracy for the model's predictions.

In an embodiment, inference module 162 processes the new data set intended for inference, using the trained and tuned model (Operation 208). It applies the model to this data, generating raw probabilistic outputs for predictions. Inference module 162 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 164 allows for applications to leverage machine learning engine 150. In an embodiment, machine learning engine API 164 may be built on a RESTful architecture and offer stateless interactions over standard HTTP/HTTPS protocols. Machine learning engine API 164 may feature a variety of endpoints, each tailored to a specific function within machine learning engine 150. In an embodiment, endpoints such as /submitData facilitate the submission of new data for processing, while /retrieveResults is designed for fetching the outcomes of data analysis or model predictions. The MLE API may also include endpoints like /pdateModel for model modifications and /trainModel to initiate training with new datasets.

In an embodiment, machine learning engine API 164 is equipped to support SOAP-based interactions. This extension involves defining a WSDL (Web Services Description Language) document that outlines the API's operations and the structure of request and response messages. In an embodiment, machine learning engine API 164 supports various data formats and communication styles. In an embodiment, machine learning engine API 164 endpoints may handle requests in JSON format or any other suitable format. For example, machine learning engine API 164 may process XML, and it may also be engineered to handle more compact and efficient data formats, such as Protocol Buffers or Avro, for use in bandwidth-limited scenarios.

In an embodiment, machine learning engine API 164 is designed to integrate WebSocket technology for applications necessitating real-time data processing and immediate feedback. This integration enables a continuous, bi-directional communication channel for a dynamic and interactive data exchange between the application and machine learning engine 150.

### 5. Generating ETL Code to Transform Normalized Database Tables and Metadata to Star Schema Denormalized Dimensions

FIG. 3 illustrates an example set of operations for generating ETL code to transform normalized database tables and metadata to star schema denormalized dimensions in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

One or more embodiments access metadata representing a database schema for an operational database having normalized data (Operation 302). The metadata representing the database schema may be accessed using SQL queries, using database-specific commands, APIs or libraries, database management tools, and/or database drivers. SQL queries may include, “list all tables in a database,” “get column details of specific tables,” and “list all indexes in a table.” Database-specific commands may include, in MySQL, commands such as “show all databases,” “show tables in a database,” “describe table structure,” or in PostgreSQL, commands such as “list tables” or “describe table structure.” APIs or libraries provided in programming languages., e.g., JAVA—Java Database Connectivity (JDBC) or Python (SQLAlchemy/SQLite) may be used to access the metadata. Database management tools, including GUI-based tools like pgAdmin, SQL Server Management Studio, MySQL Workbench, may be used to access the metadata. The metadata may be accessed using Object-Relational Mapping (ORM) tools, e.g., Hibernate, SQLAlchemy, or Entity Framework. Database drivers for accessing metadata include, for example, Open Database Connectivity or JDBC. Command-line tools for accessing metadata include, for example, MySQL Command Line or PostgreSQL psql Tool. The metadata may be accessed via rest APIs provided by the database, e.g., MongoDB Atlas API or Amazon RDS DescribeDBInstances API. Metadata may also be accessed from Object Oriented (OO) modeling tools or entity relationship (ER) modeling tools.

One or more embodiments analyze the metadata representing the schema for the operational database to identify tables and relationships between tables. (Operation 304). The system uses the metadata accessed from the database to identify and label the tables of the operational database. For example, a table may be identified and labeled as a fact table or a dimension table, or as an aggregate of a fact table, or as a shrunken dimension of a dimension table. More particularly, the system uses the metadata identify fact tables, dimension tables, base dimension tables, lookup tables, primary keys, foreign keys and constraints.

In one or more embodiments, the system identifies fact tables by a naming convention. For example, a table may have a particular prefix or suffix, e.g., _Fact or _F, indicating the table is a fact table. Fact tables may be analyzed for metadata properties. Fact tables may include quantitative data, e.g., sales amount, counts. Fact tables may also include foreign keys that link to dimension tables. Fact tables generally have outgoing foreign keys pointing to dimension tables and do not have other tables pointing to them with foreign keys. Fact tables may be identified with the assistance of machine learning models.

In one or more embodiments, the system identifies dimension tables by a naming convention. For example, a dimension table may have a particular prefix or suffix, e.g., _Dim or _D. Dimension tables may include descriptive data, e.g., product names, customer addresses. The system may identify tables with primary keys that are used as foreign keys in fact tables as dimension tables. The system may identify tables that do not have measures or aggregate data as dimension tables. The system may also use content of a table to indicate a dimension table. For example, dimension tables may include hierarchical data structures, e.g., geographic data countries, regions, cities, or product data-categories, subcategories. Related base parent and grandparent dimension tables may be identified by tracing relationships using foreign keys.

In one or more embodiments, the system uses a pattern matching mechanism, i.e., a parser, a classification or decision tree, or an ML algorithm, to identify patterns in the normalized database schema. Pattern matching assists in labeling the types of tables that form a dimension. Knowing the type of tables forming a dimension aids in understanding the relationships between the tables and the ETL operations required to join the tables.

One or more embodiments determine if a table or column is in scope for the solution (Operation 306). Determining the scope of a solution limits the tables and relationships the system needs to identify. Without determining a scope for the solution, the system may unnecessarily identify all tables and relationships in the database. The system may use scoping metadata to determine whether or not a table or column within a table is in scope for the solution. The system determines that a table is in scope when the table and/or column is referenced by a fact table and is included in the scoping metadata table describing all the tables and/or columns that are in scope.

One or more embodiments exclude table from scope (Operation 308). The system excludes from the scope of a solution tables or columns that are not referenced by a fact table. The system also excludes from scope of the solution tables or columns that are referenced by the fact table but are not included in the scoping metadata that defines the scope of the solution. Limiting a solution to tables that are in scope greatly increases the speed and efficiency.

One or more embodiments parse the dimensions that are within scope to generate an AST. (Operation 310). The system starting with the fact table identified in the database schema and traces the relationships that the fact table has with dimension tables by following foreign keys. Each time a new object or relationship is encountered a node is added to the AST and the relationship is identified, e.g., cardinality between tables, child/parent, parent/child, 1:1, 1:N, 0:N. The system creates a root node of the AST to represent the database. Child nodes are used to represent tables. Each child node may include attributes and relationships. Leaf nodes may be used to represent individual tables or columns or specific attributes. For each table in the database schema, a node is created with the attributes, i.e., columns, data types, constraints. For each relationship in the database schema, edges are added between table nodes to represent relationships, e.g., 1:N or N:1.

In one or more embodiments, the system identifies unique physical dimensions and prunes off role-playing dimensions. In this manner, role-playing dimensions only require one implementation in a star and facts will refer to the same physical normalized table with different FKs. Alternatively, different aliases, views or synonyms may be introduced to represent the role-playing dimensions. Pruning off role-playing dimensions may include determining that all roles are necessary or that the roles can be consolidated.

In one or more embodiments, the system implements optimizations, e.g., join pruning. Join pruning may be applied when a targeted table only contains a PK to be mapped. The pruned off table typically includes a language table reference. A denormalized description column will include the description associated with the PK.

In one or more embodiments, the system separates core denormalized dimensions and associated I18N description. Core denormalized dimensions are language-independent attributes of the dimension, e.g., IDs, codes, and numeric values. I18N are attributes that vary by language, e.g., names, descriptions, and labels. A core dimension table includes a unique primary key, all attributes that are language-independent, and a reference to the I18N table, if necessary. The I18N description table includes a reference to the primary key of the core dimension table, a language identifier, and language-specific attributes. By maintaining separate core denormalized dimensions and associate I18N descriptions, new languages may be added without modifying the core table. Additionally, core dimensions remain compact and performant.

One or more embodiments generate an intermediate representation from the AST that defines operations for creating denormalized dimensions. (Operation 312). Using the AST, the system identifies the dimensions to be denormalized. For each dimension, the system identifies the operations, e.g., joins, transformations, filters, required to create the denormalized dimension. Joins specify how the tables are joined using foreign keys. The system also defines the join type, e.g., inner, left. Transformations may add computed columns, e.g., concatenating names, formatting dates. Transformations may also apply functions, e.g., upper, round. Filters remove unnecessary rows to optimize the dataset, e.g., exclude rows with NULL fields. The intermediate representation may also include includes concepts such as pivoted tables of type characteristics and identifier, lookups to map description columns, and bucket tables that are used to define binned columns.

In one or more embodiments, the abstract syntax tree is processed incrementally to generate the intermediate representations. The intermediate representations include foreign keys and primary keys for the dimensions, and the operations necessary to apply to the columns to create the denormalized dimension. When a filter is required, a filter condition may be added to the intermediate representation. The intermediate representation results in a generalized description of the operations that ETL tool needs to perform. For each dimension of the AST, the operations are followed through. There may be a single operation or multiple operations required to bring all the data for the dimension together into a completed dataset. In an example, the intermediate representation may indicate that there are three (3) inner joins between four (4) of the tables and an outer join and a filter on a fifth table. The intermediate representations describes how the operations work. An xml document may be created to represent the intermediate representations. Alternatively, the system may keep the intermediate representation in memory as a set of OO models.

In one or more embodiments, the system creates PK and FK metadata for the target schema. PK and FK metadata for the target schema may include facts to dimensions and language tables to dimension tables. PK and FK metadata defines and enforces relationships between fact tables, dimension tables, and associated language tables. Foreign Keys columns may be indexed for faster joins and lookups. ETL or data modeling tools, e.g., Talend, Apache Nifi, ER/Studio, Lucidchart, may be used to manage and document PK and FK metadata. PK and FK constraints may be saved in a CSV file format.

In one or more embodiments, the system makes calculated column metadata available as metadata. Calculated column metadata describes how a column is derived, including dependencies, formula, and usage context. Calculated column metadata may be stored in a database table for easy access and integration with tools. Column metadata may be stored in various file formats including JSON, XML, YAML, and CSV.

In one or more embodiments, the system replaces columns that create column name collision, e.g., same column in multiple source tables. Columns may be replaced by using table-specific column prefixes or suffixes. A prefix or a suffix may be added to each column name based on its source table to distinguish between the columns. Alternatively, the original column names may be retained and the table name may be used as a namespace. When the columns have a same semantic meaning, e.g., id in multiple tables, the data may be merged into a unified table or the most relevant column may be selected. Duplicate columns may be dropped or excluded if the column is redundant or irrelevant to the solution. Aliases may be used to rename conflicting columns. A consolidated column mapping table may be created to track and manage renamed columns. When columns represent a same concept and come from different tables, the columns may be consolidated into one column, e.g., merge “id” columns from “orders” and “customers” into a unified “entity_id” column. Alternatively, the new column name may be provided using metadata.

In one or more embodiments, the system transforms data to address nullable or optional values and includes default rows commonly used to represent fact tables with nullable relationships to dimensions. Techniques for addressing nullable or optional values may include inserting default rows in dimension tables, using surrogate keys in fact tables, replacing NULL values with defaults, and adding “Not Applicable” rows for operational relationships. A specific surrogate key, e.g., −1, 0, or 9999, may be used to represent a default row. Nullable foreign keys may be replaced with surrogate keys pointing to the default row in the dimension table.

In a first example, a normalized dimension includes a base dimension table “B” and a parent table “P”. The base dimension table “B” has an FK relationship with non-nullable FK columns. An inner join between base table “B” and parent table “P” can be defined to denormalize the tables. In a second example, the scenario is the same as in the first example, with nullable FK columns. A left outer join between the base dimension table “B” and the parent table “P” must be defined to denormalize the tables unless the datasets define proper default rows. Inner joins can be used if the datasets joined have a default row and nullable. Additionally, nullable and optional FK columns define logic to convert NULL/optional to a default key (−1). In a third example, a base dimension table “B” is referenced by a child table “C” using an FK relationship with a 1:1 relationship. The 1:1 relationship can be inferred if the FK columns of the child table are also PK columns and a 1:1 cardinality is provided as additional metadata. An inner join between the base dimension table “B” and child table “C” creates the denormalized table. In a forth example, the scenario is the same as the third example, with FK columns expressing a 0 . . . 1:1 relationship. A left outer join between base dimension table “B” and child table “C” must be defined to denormalize the tables “T”. In a fifth example, a fact table has a nullable FK to the base dimension. All non-nullable columns of the denormalized tables must define a default value using the semantic model. This results in an NVL(..) expression during query time.

In one or more embodiments, characteristics and identifier tables are not explicitly modeled in the AST. The AST may be extended to accommodate the characteristics and identifier tables. A driver table may also be derived from the AST. By default, the driver table may be the base table of the dimension.

In one or more embodiments, characteristic and identifier tables are explicitly detected and modeled. Detection may be based on naming convention. Characteristic and identifier tables may be pivoted based on known templates for tables including name-value pairs.

One or more embodiments render the intermediate representation into target code for the ETL operations (Operation 314). The target code may be ETL code, which may conform to one or more programming languages. Using ETL tools, each of the operations are mapped to the implementation of the language to provide the same effect that is described in the AST. ETL tools that may be used to generate the target code include Apache NiFi, Talend, and traditional ETL tools, e.g., Oracle Data Integrator or Informatica.

In one or more embodiments, the process to implement denormalization of each dimension is performed using a single step approach. In the single step approach, all tables are joined using the proper inner and outer joins. In the single step approach, NULL and optional values are replaced with a default value and a default row is added. By not maintaining modified copies of the source tables, which add default values for NULL or optional N/A and a default row, the single step approach requires less storage in the data pipeline.

In one or more embodiments, the process to implement denormalization of each dimension is performed using a two-step approach. In the two-step approach, a dataset is created for each source table that replaces default values for NULL and replaces optional values for nullable/optional columns and a default row. All datasets are joined with inner joins using the same criteria as in the single step approach. The two-step approach supports automatic deletion of rows as part of incremental load.

In one or more embodiments, the system integrates manually created ETL instructions into the solution ETL and DDL for denormalized dimension tables. The system may implement binning logic as part of ETL.

One or more embodiments execute the target code on the normalized data to generate denormalized data (Operation 316). Once the target code is rendered, the system applies the transformation to the data to generate denormalized dimensions. Instantiation of the target code on the normalized data results in the extraction of the relevant data from the normalized tables. Operations are then performed on the relevant data to transform the data. The operations may include joining tables, applying filters, adding computed columns, and aggregating data. The transformed data is then loaded into a target table or file. Loading the transformed data into the target table includes defining the structure for the denormalized table and inserting the transformed data into the target table. The data in the denormalized table may be validated to ensure correctness.

In one or more embodiments, instantiation is performed using LoCode ETL logic. When using LoCode ETL logic, the data is extracted into an internal representation and subsequently transformed in multiple steps with multiple temporary datasets.

In one or more embodiments, the system is updated at a fixed interval, e.g., daily, weekly, etc. Updates may be performed when the system is not otherwise busy, e.g., overnight.

One or more embodiments execute a query using the denormalized data (Operation 318). Once the denormalized table is created, the denormalized data may be queried in a traditional manner. Generating queries for denormalized data does not require joins to combine different tables for a dimension, resulting in queries that are easier to write and understand.

An alternative approach to create the ETL code uses metadata from a semantic model. The information required from the semantic model includes sources tables for each logical dimension, join conditions and filter conditions, columns mapped, and derived columns using expressions.

### 6. Example Generation of ETL Code for Denormalizing Dimensions

A detailed example is described below for purposes of clarity. Components and/or operations described below should be understood as one specific example which may not be applicable to certain embodiments. Accordingly, components and/or operations described below should not be construed as limiting the scope of any of the claims.

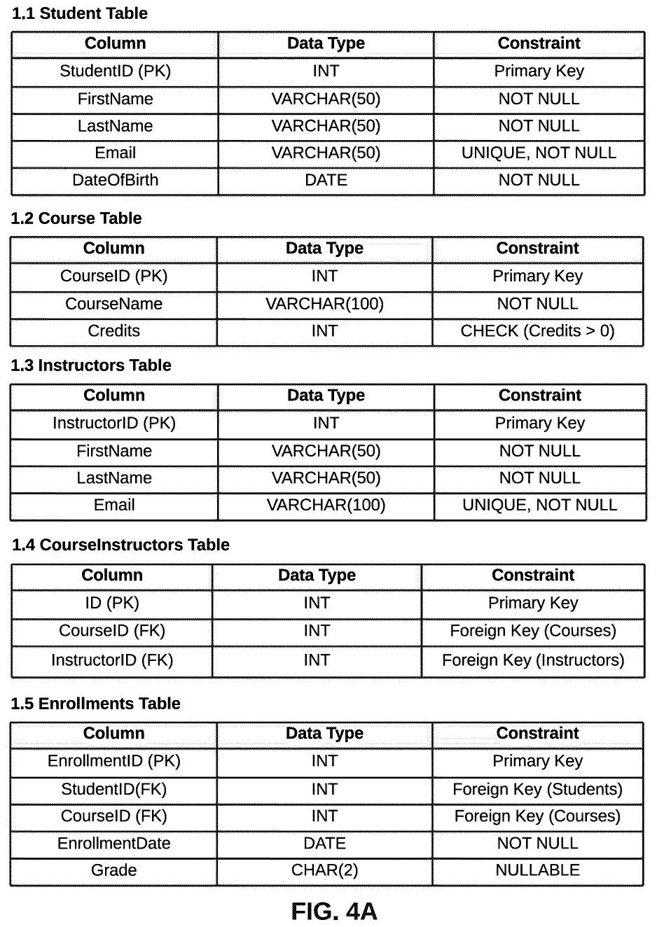

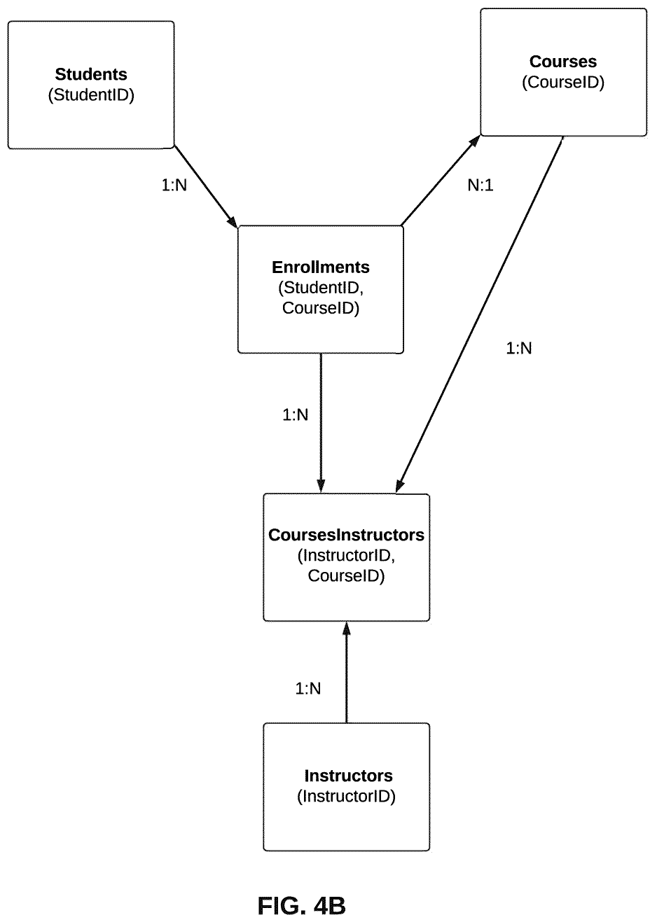

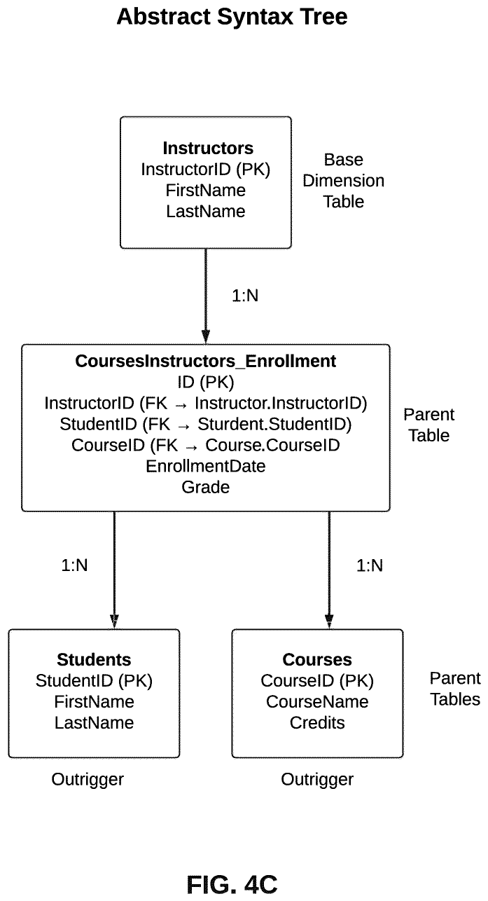

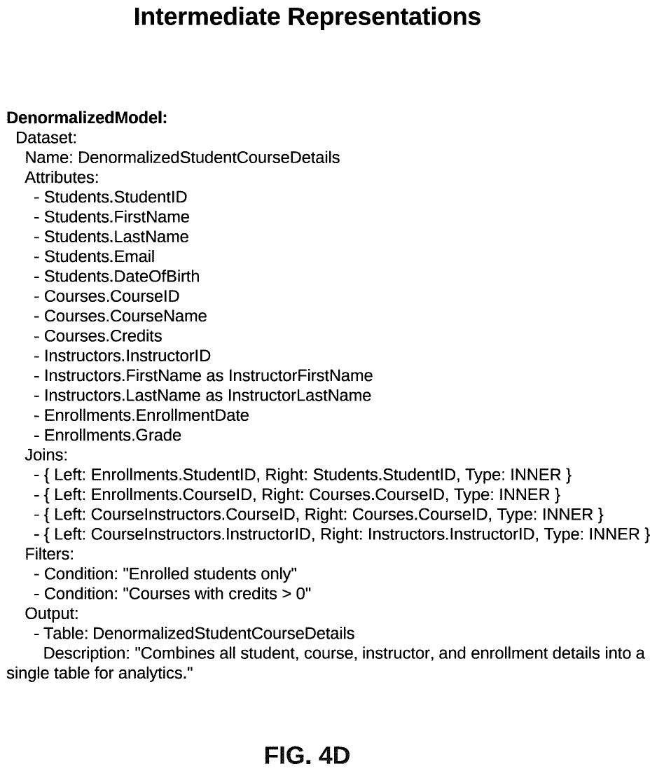

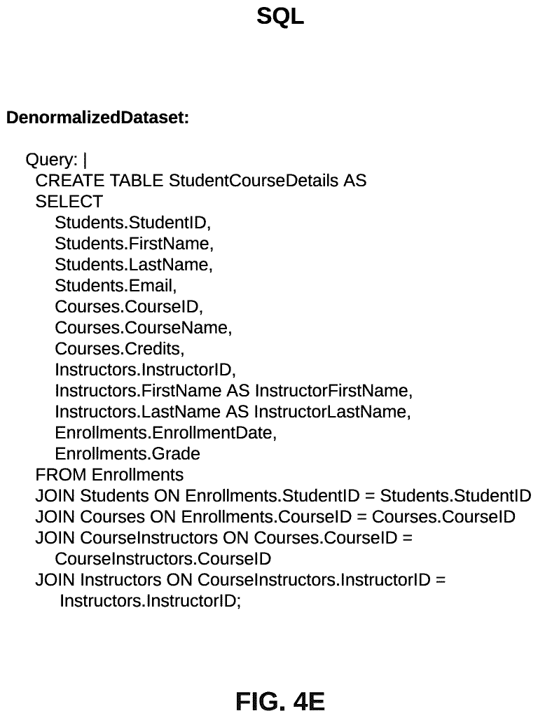

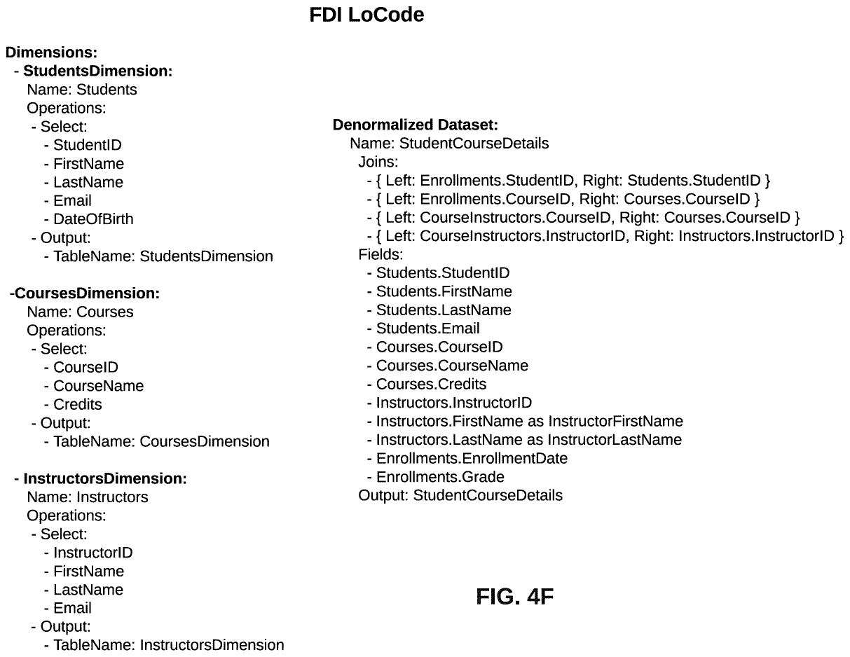

FIG. 4A is an example of metadata for a normalized database schema. The database represents a university management system. The management system handles students, courses, instructors, and enrollments. The schema adheres to 3NF, i.e., no transitive dependencies exist in any table to minimize redundancy and maintain data integrity. The normalized schema is designed to ensure data integrity, prevent duplication, and maintain flexibility.

FIG. 4B is a graphical representation of the normalized database schema shown in FIG. 4B. As illustrated, the relationship between students and enrollments is 1:n as a student can enroll in multiple courses, and an enrollment record links to a single student. The relationship between course and enrollments is 1:n as a course can have multiple students enrolled, and each enrollment links to a single course. The relationship between courses and course instructors is 1:n as a course can have multiple instructors, e.g., co-teaching or guest lectures, and each instructor assignment relates to a single course. The relationship between instructors and course instructors is 1:n as an instructor can teach multiple courses, and each instructor-course pairing is recorded in the CourseInstructors table.

FIG. 4C is an AST representation of the normalized database model. The system identifies Instructor as a base dimension table. A dataset joining CourseInstruction and Enrollment is identified as a parent table. Students and Courses are parent tables of the CourseInstruction_Enrollment table. Each node of the AST expresses a type of relationship, e.g., outrigger pattern, and content of a node refers to a table or an FK referring to the parent table. CourseInstructions_Enrollments includes a join of CourseInstructions and Enrollments. CourseInstructor_Enrollment represents a many-to-many (N:M) relationship. ID (PK) serves as a unique identifier for each enrollment.

FIG. 4D illustrates intermediate representations of the dimensions identified in the AST that describe the ETL operations for denormalizing the dimensions. The intermediate representation provides an abstract representation of datasets based on the referenced tables, projections, joins, and filters. The denormalized dataset is labeled StudentCourseDetails. The ETL operations for denormalizing the normalized data include the columns, i.e., attributes, to include in the final dataset. The attributes include StudentID, FirstName, LastName, Email from Students, CourseID, CourseName, and Credits from Courses, InstructorID, FirstName, aliased as InstructorFirstName, LastName, aliased as InstructorLastName from Instructors, and EnrollmentDate and Grade from Enrollments. Joins define the relationships between tables. Students relates to Enrollments by matching StudentID in Enrollments to StudentID in Students. Enrollments relates to Courses by matching CourseID in Enrollments to CourseID in Courses. Course relates to CourseInstructors by matching CourseID in CourseInstructors to CourseID in Courses. CourseInstructors relates to Instructors by matching InstructorID in CourseInstructors to InstructorID in Instructors. The final dataset output is the table StudentCourseDetails.

FIG. 4E illustrates sample SQL code for implementing on the normalized dimensions of the operational database to generate a denormalized star schema. Default rows may be reflected in the SQL by adding UNIONs with the default row. Similarly, FIG. 4F illustrates sample FDI LoCode for implementing on the normalized dimensions of the operational database to generate the denormalized star schema. LoCode offers a special feature to add a default row to a dataset mirroring a union between dataset and a single-row dataset with the default row. Various ETL tools may be used to render the ETL model into the target code.

In one or more embodiments,

### 7. Practical Application; Improvements & Advantages

Automatically generating ETL code to denormalize dimensions increases efficiency and reduces required effort to manually denormalize dimensions and create denormalized database schema. Denormalizing dimensions reduces the number of joins needed for queries, speeding up response times in read-intensive applications, e.g., dashboards and reporting systems. Denormalizing dimensions allows for simplified analytics. More particularly, providing a single, denormalized dataset for analysts reduces complexity in creating queries. Unlike normalized dimensions, denormalized dimensions may be more readily used by machine learning models. Additionally, denormalized dimensions may be used for downstream applications or data marts.

Denormalizing dimensions may improve query performance, simplify data access, reduce latency, enhance usability, and support aggregation. The use of denormalized dimensions reduces a need for complex joins and may speed up analytical queries. Denormalized dimensions provides a single dataset for analysts or applications, simplifying writing of queries and accessing required data. The use of denormalized dimensions minimizes computational overhead of dynamic joins during query execution.

Improvements achieved through denormalization of dimensions includes better user experience, lower system complexity, improved scalability, and enhanced data pipeline efficiency. Faster query responses lead to improved performance in dashboards and real-time applications. By reducing the reliance on joins, denormalization simplifies database maintenance and query logic. Denormalized tables can scale better in distributed systems (e.g., NoSQL databases like MongoDB or columnar stores like Redshift). ETL processes benefit from pre-joined and pre-processed datasets, enabling faster loading and processing downstream.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

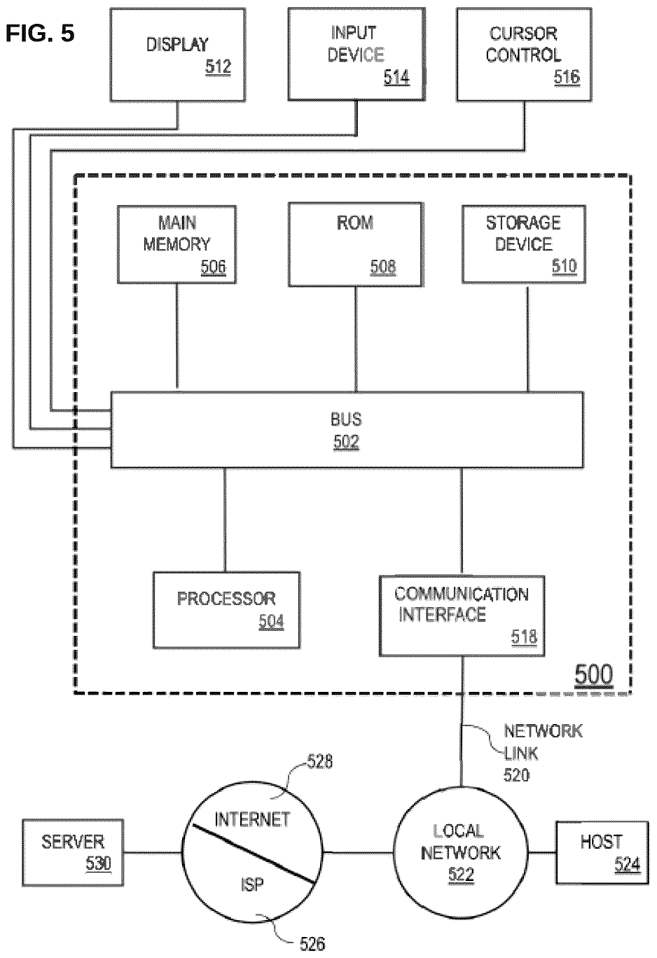

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. One or more non-transitory computer readable media comprising instructions which, when executed by one or more hardware processors, cause performance of operations comprising:
accessing metadata representing database schema for normalized data in an operational database, wherein the metadata includes one or more of: data types, primary keys, foreign keys, definitions, indexes, or constraints;
analyzing the metadata representing the database schema, including the one or more of data types, primary keys, foreign keys, definitions, indexes, or constraints, to identify tables and relationships between the tables in the operational database;
parsing the tables and the relationships between the tables to generate an abstract syntax tree (AST) representing normalized dimensions;
generating an intermediate representation from the AST, wherein generating the intermediate representation comprises defining operations for creating denormalized dimension from the normalized dimensions; and
rendering the operations of the intermediate representation into target code for creating the denormalized dimensions from the normalized dimensions.

2. The one or more non-transitory computer readable media of claim 1, where the operations further comprise:
implementing the target code on the data of the operational database to convert the normalized dimensions of the operational database into the denormalized dimensions; and
executing a query on the denormalized dimensions.

3. The one or more non-transitory computer readable media of claim 1, wherein the intermediate representations comprise operations for joining columns from the normalized dimensions.

4. The one or more non-transitory computer readable media of claim 1, wherein parsing the tables and the relationship between the tables comprises one or more of:
a. identifying cardinality of tables of the normalized data;
b. identifying hierarchies in the tables of the normalized data, or
c. identifying parent-child relationships between tables of the normalized data.

5. The one or more non-transitory computer readable media of claim 1, wherein analyzing the metadata representing the database schema comprises:
identifying one or more of:
i) fact tables,
ii) base dimension tables,
iii) relationships between fact and dimension tables,
iv) relationships between dimension tables, or
v) cardinality between tables.

6. The one or more non-transitory computer readable media of claim 1, wherein analyzing the metadata representing the database schema comprises:
identifying scoping metadata from the metadata representing the database schema; and
identifying tables that are within scope based on the scoping metadata.

7. The one or more non-transitory computer readable media of claim 1, wherein the target code is ETL code.

8. A method comprising:
accessing metadata representing database schema for normalized data in an operational database, wherein the metadata includes one or more of: data types, primary keys, foreign keys, definitions, indexes, or constraints;
analyzing the metadata representing the database schema, including the one or more of data types, primary keys, foreign keys, definitions, indexes, or constraints, to identify tables and relationships between the tables in the operational database;
parsing the tables and the relationships between the tables to generate an abstract syntax tree (AST) representing normalized dimensions;
generating an intermediate representation from the AST, wherein generating the intermediate representation comprises defining operations for creating denormalized dimension from the normalized dimensions; and
rendering the operations of the intermediate representation into target code for creating the denormalized dimensions from the normalized dimensions,
wherein the method is performed by at least one device including a hardware processor.

9. The method of claim 8, further comprising:
implementing the target code on the data of the operational database to convert the normalized dimensions of the operational database into the denormalized dimensions; and
executing a query on the denormalized dimensions.

10. The method of claim 8, wherein the intermediate representations comprise operations for joining columns from the normalized dimensions.

11. The method of claim 8, wherein parsing the tables and the relationship between the tables comprises one or more of:
a. identifying cardinality of tables of the normalized data;
b. identifying hierarchies in the tables of the normalized data, or
c. identifying parent-child relationships between tables of the normalized data.

12. The method of claim 8, wherein analyzing the metadata representing the database schema comprises:
identifying one or more of:
i) fact tables,
ii) base dimension tables,
iii) relationships between fact and dimension tables,
iv) relationships between dimension tables, or
v) cardinality between tables.

13. The method of claim 8, wherein analyzing the metadata representing the database schema comprises:
identifying scoping metadata from the metadata representing the database schema; and
identifying tables that are within scope based on the scoping metadata.

14. The method of claim 8, wherein the target code is ETL code.

15. A system comprising:
at least one device including a hardware processor;
the system being configured to perform operations comprising:
accessing metadata representing database schema for normalized data in an operational database, wherein the metadata includes the one or more of: data types, primary keys, foreign keys, definitions, indexes, or constraints;
analyzing the metadata representing the database schema, including one or more of data types, primary keys, foreign keys, definitions, indexes, or constraints, to identify tables and relationships between the tables in the operational database;
parsing the tables and the relationships between the tables to generate an abstract syntax tree (AST) representing normalized dimensions;
generating an intermediate representation from the AST, wherein generating the intermediate representation comprises defining operations for creating denormalized dimension from the normalized dimensions; and
rendering the operations of the intermediate representation into target code for creating the denormalized dimensions from the normalized dimensions.

16. The system of claim 15, where the operations further comprise:
implementing the target code on the data of the operational database to convert the normalized dimensions of the operational database into the denormalized dimensions; and
executing a query on the denormalized dimensions.

17. The system of claim 15, wherein the intermediate representations comprise operations for joining columns from the normalized dimensions.

18. The system of claim 15, wherein parsing the tables and the relationship between the tables comprises one or more of:
a. identifying cardinality of tables of the normalized data;
b. identifying hierarchies in the tables of the normalized data, or
c. identifying parent-child relationships between tables of the normalized data.

19. The system of claim 15, wherein analyzing the metadata representing the database schema comprises:
identifying one or more of:
i) fact tables,
ii) base dimension tables,
iii) relationships between fact and dimension tables,
iv) relationships between dimension tables, or
v) cardinality between tables.

20. The system of claim 15, wherein analyzing the metadata representing the database schema comprises:
identifying scoping metadata from the metadata representing the database schema; and
identifying tables that are within scope based on the scoping metadata.

21. The one or more non-transitory computer readable media of claim 1,
wherein the metadata includes primary keys and foreign keys; and
wherein analyzing metadata comprises analyzing the primary keys and the foreign keys to identify tables and relationships between the tables in the operational database.

22. The one or more non-transitory computer readable media of claim 1, wherein parsing the tables and the relationships between the tables to generate an abstract syntax tree (AST) representing normalized dimensions comprises:
identifying a fact table and dimension tables in the database schema;
tracing relationships between the fact table and the dimension tables by following foreign keys; and
adding a node to the AST each time a new object or relationship is encountered.
